(19) United States
(12) Patent Application Publication
(10) Pub. No.: US 2009/0184753 A1
(43) Pub. Date: Jul. 23, 2009

(54) CHARGE PUMP CIRCUIT

(76) Inventors: Nan Kawashima, Chiba-shi (JP); Fumiyasu Utsunomiya, Chiba-shi (JP)

Correspondence Address: Brinks Hofer Gilson & Lione/Seiko Instruments Inc., P.O. Box 10395, Chicago, IL, 60611, US

(21) Appl. No.: 12/354,486

(22) Filed: Jan. 15, 2009

(30) Foreign Application Priority Data
Jan. 23, 2008 (JP) JP2008-012625

(51) Int. Cl. G05F 1/10

(52) U.S. Cl. 327/536

(57) ABSTRACT

Provided is a charge pump circuit capable of shortening a settling time. When a boosted voltage (Vout) becomes high to be equal to or larger than an overshoot voltage, a transistor (T1) is turned on and an output terminal of the charge pump circuit is discharged. Accordingly, it is easy to reduce the boosted voltage (Vout) after an occurrence of an overshoot, and a period of time in which the boosted voltage (Vout) decreases from a voltage after the occurrence of the overshoot to a desired voltage is shortened, leading to a reduction in a settling time.

### RELATED APPLICATIONS

This application claims priority under 35 U.S.C. § 119 to Japanese Patent Application No. JP2008-012625 filed on Jan. 23, 2008, the entire content of which is hereby incorporated by reference.

### BACKGROUND OF THE INVENTION

1. Field of the Invention

The present invention relates to a charge pump circuit.

2. Description of the Related Art

A configuration of a conventional charge pump circuit is described. FIG. 5 is a diagram illustrating a conventional charge pump circuit.

The charge pump circuit includes a voltage divider circuit 23, a reference voltage circuit 28, a comparison circuit 22, an oscillator circuit 20, and a booster circuit 21.

Next, an operation of the conventional charge pump circuit is described.

The booster circuit 21 performs a boosting operation based on a pumping pulse output from the oscillator circuit 20 and outputs a boosted voltage Vout. The voltage divider circuit 23 divides the boosted voltage Vout and outputs a divided voltage Vfb1. The reference voltage circuit 28 outputs a reference voltage Vref1. The comparison circuit 22 compares the divided voltage Vfb1 with the reference voltage Vref1, and operates (performs feedback control) so that the divided voltage Vfb1 matches the reference voltage Vref1 and the boosted voltage Vout becomes a desired voltage. Further, the comparison circuit 22 controls the oscillator circuit 20 to operate when the divided voltage Vfb1 is smaller than the reference voltage Vref1 due to a load (not shown) (when the boosted voltage Vout is smaller than the desired voltage), and controls the oscillator circuit 20 to stop operating when the divided voltage Vfb1 is equal to or larger than the reference voltage Vref1 (when the boosted voltage Vout is equal to or larger than the desired voltage). The oscillator circuit 20 outputs the pumping pulse so that the booster circuit 21 performs the boosting operation when the oscillator circuit 20 operates, and does not output the pumping pulse when the oscillator circuit 20 stops operating. Here, the voltage divider circuit 23, the reference voltage circuit 28, and the comparison circuit 22 function as a voltage detection circuit 51 for detecting a voltage (for example, see JP 2004-259405 A and JP 2006-136134 A).

However, in some cases, a delay occurs in the feedback control due to, for example, a parasitic capacitance present in a feedback system ranging from an output terminal of the charge pump circuit to the oscillator circuit 20, whereby overshoot occurs at the output terminal of the charge pump circuit. Therefore, after the overshoot occurs, it takes a long period of time for the boosted voltage Vout to decrease from a voltage after the occurrence of the overshoot to the desired voltage in some cases, which may lengthen a settling time (period of time in which the boosted voltage Vout becomes the desired voltage).

### SUMMARY OF THE INVENTION

The present invention has been made in view of the above-mentioned problem, and therefore an object thereof is to provide a charge pump circuit capable of shortening a settling time.

In order to solve the above-mentioned problem, the present invention provides a charge pump circuit including: a booster circuit; a voltage detection circuit; an oscillator circuit; and a discharge circuit, the booster circuit performing a boosting operation based on a pumping pulse output from the oscillator circuit and outputting a boosted voltage, the voltage detection circuit operating so that the boosted voltage becomes a desired voltage by controlling the oscillator circuit to operate when the boosted voltage is smaller than the desired voltage and controlling the oscillator circuit to stop operating when the boosted voltage is equal to or larger than the desired voltage, the oscillator circuit outputting the pumping pulse so that the booster circuit performs the boosting operation when operating, and not outputting the pumping pulse when stopping operating, the discharge circuit not discharging an output terminal of the charge pump circuit when the boosted voltage is smaller than an overshoot voltage, and discharging the output terminal of the charge pump circuit when the boosted voltage is equal to or larger than the overshoot voltage.

In the present invention, when the boosted voltage becomes high to be equal to or larger than the overshoot voltage, the output terminal of the charge pump circuit is discharged. Accordingly, it is easy to reduce the boosted voltage after the occurrence of the overshoot, and a period of time in which the boosted voltage decreases from the voltage after the occurrence of the overshoot to the desired voltage is shortened, leading to a reduction in settling time.

### BRIEF DESCRIPTION OF THE DRAWINGS

In the accompanying drawings:

FIG. 1 is a diagram illustrating an example of a charge pump circuit;

FIG. 2 is a diagram illustrating another example of the charge pump circuit;

FIG. 3 is a diagram illustrating still another example of the charge pump circuit;

FIG. 4 is a diagram illustrating still another example of the charge pump circuit; and

FIG. 5 is a diagram illustrating a conventional charge pump circuit.

### DETAILED DESCRIPTION OF THE PREFERRED EMBODIMENT

Hereinafter, an embodiment of the present invention is described with reference to the drawings.

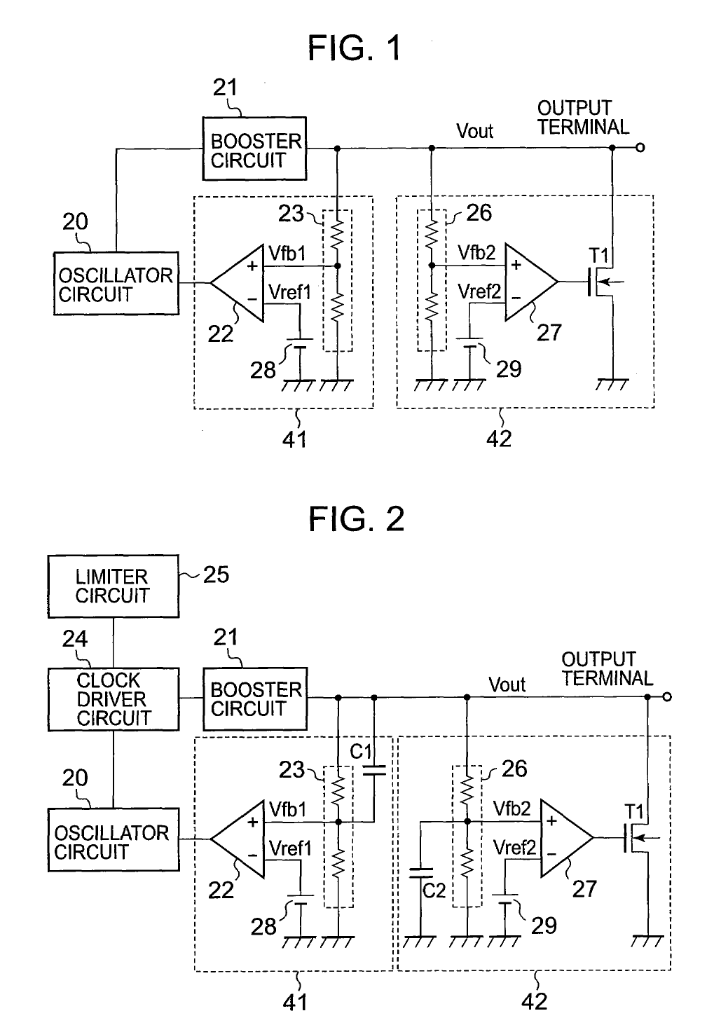

First, a configuration of a charge pump circuit is described. FIG. 1 is a diagram illustrating an example of the charge pump circuit.

The charge pump circuit includes a voltage divider circuit 23, a reference voltage circuit 28, a comparison circuit 22, an oscillator circuit 20, and a booster circuit 21. In addition, the charge pump circuit includes a voltage divider circuit 26, a reference voltage circuit 29, a comparison circuit 27, and a transistor T1.

The voltage divider circuit 23 is provided between an output terminal of the charge pump circuit and a ground terminal. The reference voltage circuit 28 is provided between an inverting input terminal of the comparison circuit 22 and the ground terminal. In the comparison circuit 22, a non-inverting input terminal thereof is connected to an output terminal of the voltage divider circuit 23, and an output terminal thereof is connected to an input terminal of the oscillator circuit 20. In the oscillator circuit 20, an output terminal thereof is connected to an input terminal of the booster circuit 21. In the booster circuit 21, an output terminal thereof is connected to the output terminal of the charge pump circuit.

The voltage divider circuit 26 is provided between the output terminal of the charge pump circuit and the ground terminal. The reference voltage circuit 29 is provided between an inverting input terminal of the comparison circuit 27 and the ground terminal. In the comparison circuit 27, a non-inverting input terminal thereof is connected to an output terminal of the voltage divider circuit 26, and an output terminal thereof is connected to a gate of the transistor T1. In the transistor T1, a source thereof is connected to the ground terminal, and a drain thereof is connected to the output terminal of the charge pump circuit.

Here, a boosted voltage Vout when a divided voltage Vfb1 is equal to a reference voltage Vref1 is a desired voltage, and the desired voltage is determined through circuit design for the divided voltage Vfb1 and the reference voltage Vref1. Further, the boosted voltage Vout when a divided voltage Vfb2 is equal to a reference voltage Vref2 is an overshoot voltage, and the over shoot voltage is determined through circuit design for the divided voltage Vfb2 and the reference voltage Vref2. The overshoot voltage is higher than the desired voltage.

Next, an operation of the charge pump circuit is described.

The booster circuit 21 performs a boosting operation based on a pumping pulse output from the oscillator circuit 20 and outputs the boosted voltage Vout. The divider circuit 23 divides the boosted voltage Vout and outputs the divided voltage Vfb1. The reference voltage circuit 28 outputs the reference voltage Vref1. The comparison circuit 22 compares the divided voltage Vfb1 with the reference voltage Vref1 and operates (performs feedback control) so that the divided voltage Vfb1 matches the reference voltage Vref1 and the boosted voltage Vout becomes the desired voltage. Further, the comparison circuit 22 controls the oscillator circuit 20 to operate when the divided voltage Vfb1 is smaller than the reference voltage Vref1 due to a load (not shown) (when the boosted voltage Vout is smaller than the desired voltage), and controls the oscillator circuit 20 to stop operating when the divided voltage Vfb1 is equal to or larger than the reference voltage Vref1 (when the boosted voltage Vout is equal to or larger than the desired voltage). The oscillator circuit 20 outputs a pumping pulse so that the booster circuit 21 performs a boosting operation when the oscillator circuit 20 operates, and does not output a pumping pulse when the oscillator circuit 20 stops operating. Here, the voltage divider circuit 23, the reference voltage circuit 28, and the comparison circuit 22 function as a voltage detection circuit 41 for detecting a voltage.

Further, the voltage divider circuit 26 divides the boosted voltage Vout and outputs the divided voltage Vfb2. The reference voltage circuit 29 outputs the reference voltage Vref2. The comparison circuit 27 compares the divided voltage Vfb2 with the reference voltage Vref2. Then, the comparison circuit 27 controls the transistor T1 to be turned off when the divided voltage Vfb2 is smaller than the reference voltage Vref2 (when the boosted voltage Vout is smaller than the overshoot voltage), and controls the transistor T1 to be turned on when the divided voltage Vfb2 is equal to or larger than the reference voltage Vref2 (when the boosted voltage Vout is equal to or larger than the overshoot voltage). The transistor T1 is turned off when the divided voltage Vfb2 is smaller than the reference voltage Vref2, and is turned on to discharge the output terminal of the charge pump circuit when the divided voltage Vfb2 is equal to or larger than the reference voltage Vref2. Here, the voltage divider circuit 26, the reference voltage circuit 29, the comparison circuit 27, and the transistor T1 function as a discharge circuit 42 capable of discharging the output terminal of the charge pump circuit.

Here, the boosted voltage Vout decreases when the transistor T1 is turned on, and the transistor T1 is turned off immediately when the boosted voltage Vout becomes smaller than the overshoot voltage.

As a result, when the boosted voltage Vout becomes high to be equal to or larger than the overshoot voltage, the transistor T1 is turned on and the output terminal of the charge pump circuit is discharged. Accordingly, it is easy to reduce the boosted voltage Vout after the occurrence of the overshoot, and a period of time in which the boosted voltage Vout decreases from the voltage after the occurrence of the overshoot to the desired voltage is shortened, leading to a reduction in settling time.

Further, the oscillator circuit 20 stops operating when the divided voltage Vfb1 is equal to or larger than the reference voltage Vref1, whereby power consumption of the charge pump circuit is reduced.

Further, irrespective of whether resistance values of the voltage divider circuit 23 and the voltage divider circuit 26 become small, the output terminal of the charge pump circuit is discharged when the transistor T1 is turned on. Therefore, the resistance values of the voltage divider circuit 23 and the voltage divider circuit 26 may be large, and there is no need to make circuit design so that a performance of the booster circuit 21 is high because of small resistance values of the voltage divider circuit 23 and the voltage divider circuit 26. Accordingly, an area and power consumption for the circuit are reduced.

It should be noted that, when the overshoot voltage is made to be close to the desired voltage, correspondingly, the transistor T1 is turned on and the output terminal of the charge pump circuit is more easily discharged. As a result, a period of time in which the boosted voltage Vout decreases from the voltage after the occurrence of the overshoot to the desired voltage is shortened, leading to a reduction in settling time.

Further, when a driving performance of the transistor T1 is large, a discharge rate is increased. Accordingly, a period of time in which the boosted voltage Vout decreases from the voltage after the occurrence of the overshoot to the desired voltage is shortened, leading to a reduction in settling time.

Further, as illustrated in FIG. 2, a capacitor C1 may be provided between the output terminal of the charge pump circuit and the output terminal of the voltage divider circuit 23. Then, a reaction rate of the comparison circuit 22 becomes fast, and hence the boosted voltage Vout is appropriately controlled and easily decreases to the desired voltage, leading to a reduction in settling time.

Further, as illustrated in FIG. 2, a capacitor C2 may be provided between the output terminal of the voltage divider circuit 26 and the ground terminal. Then, a ripple component of the boosted voltage Vout is removed, and malfunction of the comparison circuit 27 occurs less frequently, with the result that the boosted voltage Vout is appropriately controlled and easily decreases to the desired voltage, leading to a reduction in settling time.

Further, as illustrated in FIG. 2, a clock driver circuit 24 which includes a buffer (not shown) and drives a pumping pulse may be provided between the output terminal of the oscillator circuit 20 and the input terminal of the booster circuit 21, and a limiter circuit 25 which limits, to a predetermined value, a peak value of the pumping pulse output from the clock driver circuit 24 after being driven may be connected to the clock driver circuit 24. Then, even when a power supply voltage becomes high through fluctuation, the peak value of the pumping pulse becomes smaller than the predetermined value, and a ripple of the pumping pulse is not increased. As a result, the boosted voltage Vout is appropriately controlled and easily decreases to the desired voltage, leading to a reduction in settling time.

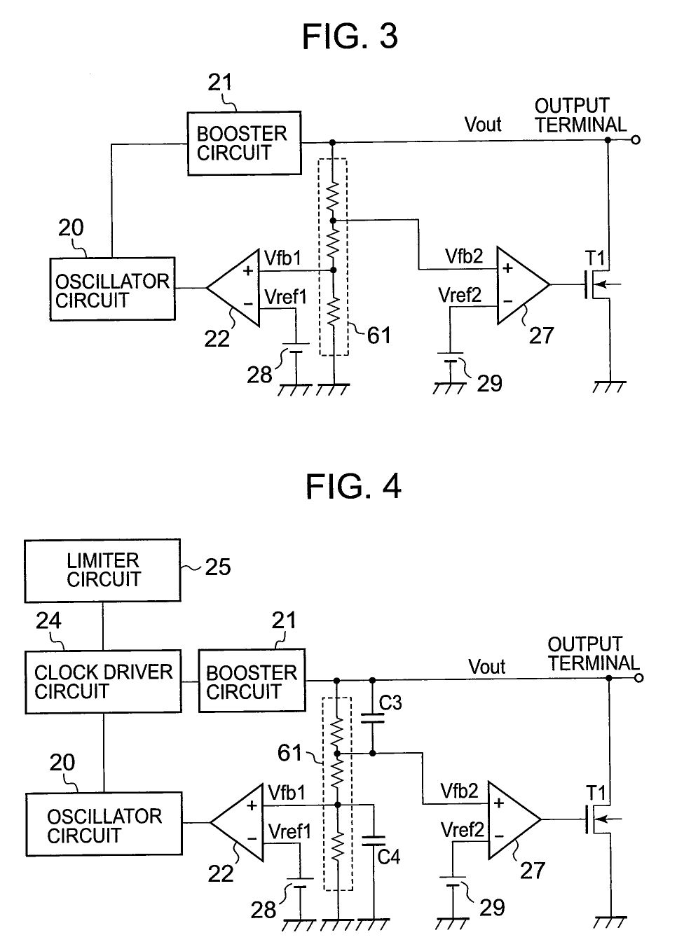

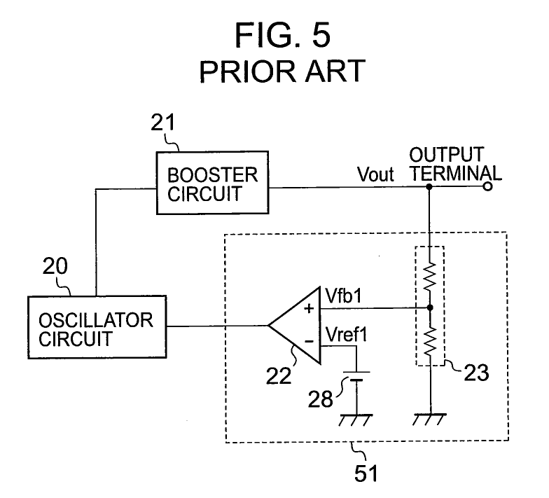

Further, in FIG. 1, the voltage divider circuit 23 and the voltage divider circuit 26 output the divided voltage Vfb1 and the divided voltage Vfb2, respectively. However, as illustrated in FIG. 3, one voltage divider circuit 61 may output the divided voltage Vfb1 and the divided voltage Vfb2.

Further, in FIG. 2, the voltage divider circuit 23 and the voltage divider circuit 26 output the divided voltage Vfb1 and the divided voltage Vfb2, respectively. However, as illustrated in FIG. 4, one voltage divider circuit 61 may output the divided voltage Vfb1 and the divided voltage Vfb2. In this case, the capacitors C1 and C2 are removed, a capacitor C3 is added between the output terminal of the charge pump circuit and the non-inverting input terminal of the comparison circuit 27, and a capacitor C4 is added between the ground terminal and the non-inverting input terminal of the comparison circuit 22.

Further, the reference voltage circuit 28 and the reference voltage circuit 29 are provided, but one reference voltage circuit (not shown) may be provided. In this case, two reference voltages are generated by a voltage divider circuit (not shown) or the like in the case where the reference voltages used by the comparison circuit 22 and the comparison circuit 27 are different from each other.

What is claimed is:

1. A charge pump circuit, comprising:
a booster circuit;
a voltage detection circuit;
an oscillator circuit; and
a discharge circuit,
the booster circuit performing a boosting operation based on a pumping pulse output from the oscillator circuit and outputting a boosted voltage,
the voltage detection circuit operating so that the boosted voltage becomes a desired voltage by controlling the oscillator circuit to operate when the boosted voltage is smaller than the desired voltage and controlling the oscillator circuit to stop operating when the boosted voltage is equal to or larger than the desired voltage,
the oscillator circuit outputting the pumping pulse so that the booster circuit performs the boosting operation when operating, and not outputting the pumping pulse when stopping operating,
the discharge circuit not discharging an output terminal of the charge pump circuit when the boosted voltage is smaller than an overshoot voltage, and discharging the output terminal of the charge pump circuit when the boosted voltage is equal to or larger than the overshoot voltage.

2. A charge pump circuit according to claim 1, further comprising:
a clock driver circuit which is provided between an output terminal of the oscillator circuit and an input terminal of the booster circuit and includes a buffer, for driving the pumping pulse; and
a limiter circuit connected to the clock driver circuit for limiting a peak value of the pumping pulse output from the clock driver circuit after being driven to a predetermined value.

3. A charge pump circuit according to claim 1, wherein: the voltage detection circuit includes:
a first voltage divider circuit for dividing the boosted voltage and outputting a first divided voltage;
a first reference voltage circuit for outputting a first reference voltage; and
a first comparison circuit for comparing the first divided voltage with the first reference voltage to operate so that the first divided voltage matches the first reference voltage and the boosted voltage becomes the desired voltage by controlling the oscillator circuit to operate when the first divided voltage is smaller than the first reference voltage and the boosted voltage is smaller than the desired voltage and controlling the oscillator circuit to stop operating when the first divided voltage is equal to or larger than the first reference voltage and the boosted voltage is equal to or larger than the desired voltage; and
the discharge circuit includes:
a transistor;
a second voltage divider circuit for dividing the boosted voltage and outputting a second divided voltage;
a second reference voltage circuit for outputting a second reference voltage; and
a second comparison circuit for comparing the second divided voltage with the second reference voltage, controlling the transistor to be turned off when the second divided voltage is smaller than the second reference voltage and the boosted voltage is smaller than the overshoot voltage, and controlling the transistor to be turned on when the second divided voltage is equal to or larger than the second reference voltage and the boosted voltage is equal to or larger than the overshoot voltage.

4. A charge pump circuit according to claim 3, further comprising a capacitor provided between the output terminal of the charge pump circuit and an output terminal of the first voltage divider circuit.

5. A charge pump circuit according to claim 3, further comprising a capacitor provided between an output terminal of the second voltage divider circuit and a ground terminal.

6. A charge pump circuit according to claim 1, wherein: the voltage detection circuit includes:
a voltage divider circuit for dividing the boosted voltage and outputting a first divided voltage and a second divided voltage;
a first reference voltage circuit for outputting a first reference voltage; and
a first comparison circuit for comparing the first divided voltage with the first reference voltage to operate so that the first divided voltage matches the first reference voltage and the boosted voltage becomes the desired voltage by controlling the oscillator circuit to operate when the first divided voltage is smaller than the first reference voltage and the boosted voltage is smaller than the desired voltage and controlling the oscillator circuit to stop operating when the first divided voltage is equal to or larger than the first reference voltage and the boosted voltage is equal to or larger than the desired voltage; and
the discharge circuit includes:
a transistor;
the same voltage divided circuit;
a second reference voltage circuit for outputting a second reference voltage; and
a second comparison circuit for comparing the second divided voltage with the second reference voltage, controlling the transistor to be turned off when the second divided voltage is smaller than the second reference voltage and the boosted voltage is smaller than the overshoot voltage, and controlling the transistor to be turned on when the second divided voltage is equal to or larger than the second reference voltage and the boosted voltage is equal to or larger than the overshoot voltage.

7. A charge pump circuit according to claim 6, further comprising a capacitor provided between the output terminal of the charge pump circuit and a first output terminal of the voltage divider circuit.

8. A charge pump circuit according to claim 6, further comprising a capacitor provided between a second output terminal of the voltage divider circuit and a ground terminal.
